(19) United States
(12) Patent Application Publication
(10) Pub. No.: US 2012/0228950 A1
(43) Pub. Date: Sep. 13, 2012

(54) STABILIZATION SYSTEM, POWER SUPPLY SYSTEM, CONTROL METHOD OF THE MASTER MANAGEMENT DEVICE AND PROGRAM FOR THE MASTER MANAGEMENT DEVICE

(75) Inventor: Souichi SAKAI, Moriguchi-shi (JP)

(73) Assignee: SANYO Electric Co., Ltd., Moriguchi-shi (JP)

(21) Appl. No.: 13/425,206

(22) Filed: Mar. 20, 2012

Related U.S. Application Data
(63) Continuation of application No. PCT/JP2011/058134, filed on Mar. 30, 2011.

(30) Foreign Application Priority Data
Mar. 30, 2010 (JP) 2010-078933

(51) Int. Cl. H02J 1/00

(52) U.S. Cl. 307/84; 307/43

(57) ABSTRACT

This stabilization system providing plural power supply systems, the power supply systems comprising, distributed type power sources, and detection unit detecting the power passing through specific parts of the distribution lines between the distributed type power sources and the power grid, wherein smoothing control is performed on the power output to the power grid based on the detected power output data of the detection unit, and said plural power supply systems include a first power supply system performing smoothing control in the event that the amount of fluctuation of the value of said detected power output is not less than a first threshold value, and a second power supply system performing smoothing control in the event that the amount of fluctuation of the value of said detected power output is not less than a second threshold value which is greater than the first threshold value.

### CROSS-REFERENCE TO RELATED APPLICATIONS

This application is a continuation of International Application No. PCT/JP2011/058134, filed Mar. 30, 2011, which claims priority from Japanese Patent Application No. 2010-078933, filed Mar. 30, 2010, the entire contents of which are incorporated herein by reference.

### FIELD OF INDUSTRIAL USE

The present invention relates to a stabilization system, a power supply system, a control method of the master management device and a program for the master management device.

### PRIOR ART

In recent years, the number of instances where power generators (such as solar cells and the like) utilizing natural energy such as wind power or sunlight are connected to consumers (e.g. consumer homes and factories) in receipt of a supply of alternating current power from an electricity substation has increased. These types of power generators are connected to the power grid subordinated to a substation. And power generated by the generators is output to the power consuming devices side of the consumer location. The superfluous electric power, which is not consumed by the power consuming devices in the consumer location, is output to the power grid. The flow of this power towards the power grid from the consumer location is termed “counter-current flow”, and the power output from the consumer to the power grid is termed “counter-current power”.

In this situation the power suppliers, such as the power companies and the like, have a duty to ensure the stable supply of electric power and need to maintain the stability of the frequency and voltage of the overall power grid, including the counter-current power components. For example, the power supply companies maintain the stability of the frequency of the overall power grid by a plurality of control methods in correspondence with the size of the fluctuation period. Specifically, in general, in respect of a load component with a fluctuation period of some tens of minutes, economic dispatching control (EDC) is performed to enable output sharing of the generated amount in the most economic manner. This EDC is controlled based on the daily load fluctuation expectation, and it is difficult to respond to the increases and decreases momentarily in the load fluctuation (the components of the fluctuation period which are less than the order of 20 minutes). In that instance, the power companies adjust the amount of power supplied to the power grid in correspondence with the load fluctuated momentarily, and perform plural controls in order to stabilize the frequency. Other than the EDC, these controls are called frequency controls, in particular, and the adjustments of the load fluctuation components not enabled by the adjustments of the EDC are enabled by these frequency controls.

More specifically, for the components with a fluctuation period of less than approximately 10 seconds, their absorption is enabled naturally by means of the endogenous control functions of the power grid itself. Moreover, for the components with a fluctuation period of about 10 seconds to the order of several minutes, they can be dealt with by the governor-free operation of the generators in each generating station. Furthermore, for the components with a fluctuation period of the order of several minutes to 20 minutes, they can be dealt-with by load frequency control (LFC). In this load frequency control, the frequency control is performed by the adjustment of the power output of the generating station for LFC by means of a control signal from the central power supply command station of the power supplier.

However, the output of power generators utilizing natural energy may vary abruptly in correspondence with the weather and such like. This abrupt fluctuation in the power output of this type of power generator applies a gross adverse impact on the degree of stability of the frequency of the power grid they are connected to. This adverse impact becomes more pronounced as the number of consumers with power generators using natural energy increases. As a result, in the event that the number of consumers with power generators utilizing natural energy increases even further henceforth, there will be a need arising for sustenance of the stability of the power grid by the control of the abrupt fluctuation in the output of the power generators.

In relation to that, there have been proposals, conventionally, to provide power generation systems with batteries to enable smoothing of the output of the solar cells to the power grid by the charge and discharge thereof in order to suppress the abrupt fluctuations in the output of the power generators. Such a power generation system was disclosed, for example, in Japanese laid-open patent publication No. 2001-346332.

In the Japanese laid-open published patent specification 2001-346332 described above, there is the disclosure of a power system provided with solar cells, and invertors which are connected to both the solar cells and the power grid, and a battery which is connected to a bus connecting the inverter and the solar cells. In this power generation system, by performing charging and discharging of a battery in tandem with the fluctuation of the generated power (output) of the solar cells, the fluctuations in the power output from the inverter may be suppressed. By this means, because the suppression in the fluctuations in the power output to the power grid is enabled, the suppression of the adverse effects on the frequency of the power grid and the like is enabled. Moreover, in this power generation system, when the amount of fluctuation of the power output becomes greater than a specific (threshold) value, the smoothing control is initiated. By this means, because the duration of the performance of smoothing control (The charge and discharge of the battery) becomes shorter, the reduction in the amount of charge and discharge of the battery is enabled, and as a result, a contrivance at the lengthening of the lifetime of the battery is considered possible.

### PRIOR ART REFERENCES

Patent Reference #1: Japanese laid-open published patent specification 2001-346332.

### OUTLINE OF THE INVENTION

### Problems to be Solved by the Invention

However, in the Japanese laid-open published patent specification 2001-346332 described above, when the threshold value for the initiation of smoothing control is made larger, while a contrivance at lengthening of the lifetime of the battery is enabled by reducing the amount of the charging and discharging of the battery, because the duration of the performance of the smoothing control is reduced, it is difficult to achieve sufficient smoothing of the power output to the power grid. Moreover, when the threshold value for the initiation of smoothing control is reduced, because the reduction effect in the amount of charging and discharging of the battery is reduced, this gives rise to the problem that the reduction in the amount of charge and discharge of the battery is insufficient.

This invention was conceived of to resolve the type of problems described above, and one object of this invention is the provision of stabilization system, which enables a contrivance at lengthening the lifetime of the power storage system in addition to sufficiently smoothing the fluctuations of the power output to the power grid, a power supply system, a control method for a master management device and a program for the master management device.

### SUMMARY OF THE INVENTION

In order to achieve the objectives described above, the stabilization system of the present invention provides plural power supply systems, and the power supply systems comprise distributed type power sources, and detection unit detecting the power passing through specific parts of the distribution lines between the distributed type power sources and the power grid, wherein smoothing control is performed on the power output to the power grid based on the detected power output data of the detection unit, and the plural power supply systems include a first power supply system performing smoothing control in the event that the amount of fluctuation of the value of the detected power output is not less than a first threshold value, and a second power supply system performing smoothing control in the event that the amount of fluctuation of the value of the detected power output is not less than a second threshold value which is greater than the first threshold value.

The power supply system of the present invention is a power supply system performing smoothing control on the power output to the power grid, the power supply system includes distributed power sources, and the distributed power source comprises power generation devices generating power from renewable energy and power detection devices detecting the power passing through specific parts of the distribution lines between the distributed type power sources and the power grid, wherein the power supply system not only performs smoothing control when the amount of fluctuation in the value of the detected power output is in excess of a specific threshold value, based on the detected power output data of the power output detection device, but also employs as the specific threshold value, the mutually replaceable first threshold value, and a second threshold value which is greater than the first threshold value.

### Benefits of the Present Invention

By means of the present invention, with the first threshold value as a standard for the first power supply system, because the amount of charge and discharge of the battery of the second power supply system performing smoothing control using a second threshold value can be reduced, when the totality of an area is looked at, a contrivance at the lengthening of the lifetime of the battery in the area is enabled.

Moreover, by setting an appropriately sized second threshold value, the inventors discovered that even by providing second power supply systems in the area determining the performance of smoothing control by means of the second threshold value which is greater than the first threshold value, that the performance of smoothing (The suppression of the fluctuations in the power output to the power grid) at substantially the same level as when all the power supply system in the area employed the first threshold value was enabled. Therefore, in a stabilization system in a first situation, the fluctuation of the power output to the power grid could be sufficiently smoothed, in addition to enabling a contrivance at lengthening the lifetime of the battery.

### BRIEF DESCRIPTION OF THE DRAWINGS

FIG. 1 is a schematic view showing the configuration of the stabilization system (First state) of embodiment 1 of the present invention.

FIG. 2 is a schematic view showing the configuration of the stabilization system (Second state) of embodiment 1 of the present invention.

FIG. 3 is a block diagram showing the configuration of PV systems using the stabilization system of embodiment 1 of the present invention.

FIG. 4 is a drawing to explain the relationship of intensity of load fluctuations and the fluctuation periods in respect of the power grid.

FIG. 5 is a flow chart in order to explain the flow of the control of the smoothing control of the PV system (The first threshold value of the power generation system 1a) of the first embodiment shown in FIG. 1.

FIG. 6 is a flow chart in order to explain the flow of the control of the smoothing control of the PV system (The second threshold value of the power generation system 1b) of the first embodiment shown in FIG. 1.

FIG. 7 is a diagram in order to explain the sampling period in the smoothing control.

FIG. 8 is a graph to explain the trends in the power output of the power generators on the 23^{rd} of May (a day where the fluctuations of the power output were relatively severe).

FIG. 9 is a graph to explain the size of fluctuations in the power output of the power generators on the 23^{rd} of May (a day where the fluctuations of the power output were relatively severe).

FIG. 10 is a graph to explain the trends in the power output of the power generators on the 24^{th} of August (a day where the fluctuations of the power output were relatively severe).

FIG. 11 is a graph to explain the size of fluctuations in the power output of the power generators on the 24^{th} of August (a day where the fluctuations of the power output were relatively severe).

FIG. 12 is a graph to explain the trends in the power output of the power generators on the 16^{th} of February (a day where the fluctuations of the power output were relatively severe).

FIG. 13 is a graph to explain the size of fluctuations in the power output of the power generators on the 16^{th} of February (a day where the fluctuations of the power output were relatively severe).

FIG. 14 is a graph to explain the trends in the power output of the power generators on the 19^{th} of May (a day where the fluctuations of the power output were relatively mild).

FIG. 15 is a graph to explain the size of fluctuations in the power output of the power generators on the 19^{th} of May (a day where the fluctuations of the power output were relatively mild).

FIG. 16 is a graph to explain the trends in the power output of the power generators on the 6^{th} of August (a day where the fluctuations of the power output were relatively mild).

FIG. 17 is a graph to explain the size of fluctuations in the power output of the power generators on the 6^{th} of August (a day where the fluctuations of the power output were relatively mild).

FIG. 18 is a graph to explain the trends in the power output of the power generators on the 5^{th} of February (a day where the fluctuations of the power output were relatively mild).

FIG. 19 is a graph to explain the size of fluctuations in the power output of the power generators on the 5^{th} of February (a day where the fluctuations of the power output were relatively mild).

FIG. 20 is a graph showing the FFT analysis results of the situations where smoothing control was performed by means of the embodiments and by means of the comparative example in respect of output of the power generators on the 19^{th} of May (a day where the fluctuations of the power output were relatively mild).

FIG. 21 is a graph showing the FFT analysis results of the situations where smoothing control was performed by means of the embodiments and by means of the comparative example in respect of output of the power generators on the 23^{rd} of May (a day where the fluctuations of the power output were relatively severe).

FIG. 22 is a graph showing the FFT analysis results of the situations where smoothing control was performed by means of the embodiments and by means of the comparative example in respect of output of the power generators on the 6^{th} of August (a day where the fluctuations of the power output were relatively mild).

FIG. 23 is a graph showing the FFT analysis results of the situations where smoothing control was performed by means of the embodiments and by means of the comparative example in respect of output of the power generators on the 24^{th} of August (a day where the fluctuations of the power output were relatively severe).

FIG. 24 is a graph showing the FFT analysis results of the situations where smoothing control was performed by means of the embodiments and by means of the comparative example in respect of output of the power generators on the 5^{th} of February (a day where the fluctuations of the power output were relatively mild).

FIG. 25 is a graph showing the FFT analysis results of the situations where smoothing control was performed by means of the embodiments and by means of the comparative example in respect of output of the power generators on the 16^{th} of February (a day where the fluctuations of the power output were relatively severe).

FIG. 26 is a block diagram showing the configuration of power generation systems using the stabilization system of embodiment 2 of the present invention.

FIG. 27 is a schematic view showing the configuration of a modified embodiment of the stabilization system of embodiment 1 of the present invention.

### BEST METHOD OF EMBODYING THE INVENTION

Hereafter the embodiments of the present invention are explained based on the figures.

### Embodiment 1

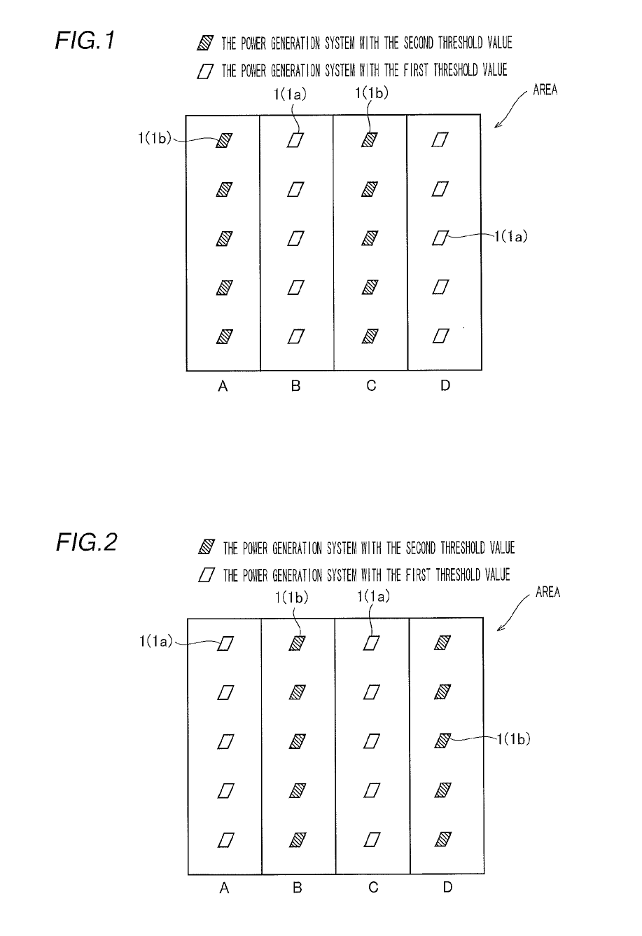

Firstly, the configuration of the stabilization system of embodiment 1 of the present invention is explained while referring to FIGS. 1-4.

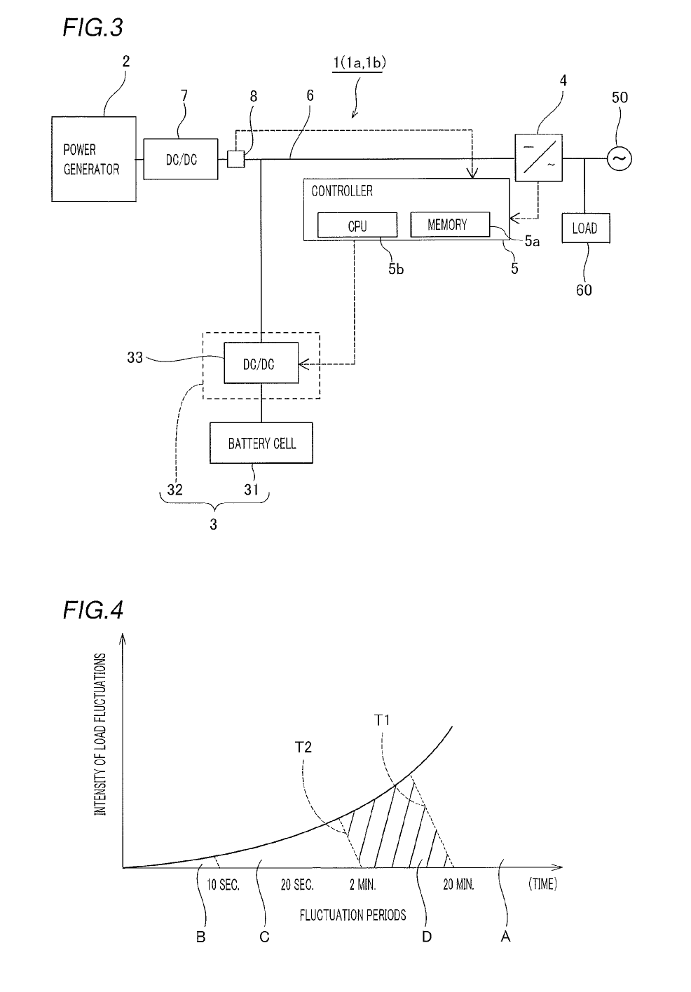

As shown in FIG. 1 and FIG. 2, the stabilization system of embodiment 1 provides plural photovoltaic systems(PV systems) 1 disposed in a specific area. As shown in FIG. 3, the PV systems 1 are each connected to the power grid 50, and the surplus power of the power generated by the solar cells (hereafter referred to as the power generator 2) after consumption by the load is counter current flowed into the power grid 50. Now, the specific area is, for example, the management region of a power company. The PV systems 1, have a smoothing control function enabling the smoothing of the fluctuations in the counter current power to the power grid 50 by means of the charge and discharge of the battery cell 31. Now, the PV systems 1 are but one example of the ‘power supply systems’ of the present invention. Moreover, the power generator 2 is but one example of the ‘distributed-type power source’ of the present invention.

Moreover, as will be described below, the PV systems 1, when the amount of fluctuation of the power output of the solar cells (the power generator 2) exceeds a specific threshold value (the control initiating fluctuation amount), smoothing control is initiated. Here, in embodiment 1, the PV systems 1 can modify the threshold value. The PV systems 1 have the functions of the power generation system 1a determining the initiation of the smoothing control by means of a small threshold value (the first threshold value), and the power generation system 1b determining the initiation of the smoothing control by means of a threshold value (the second threshold value) which is larger than the first threshold value. Now, the power generation system 1a and the power generation system 1b of the present invention are each examples of the ‘first power supply system’ and the ‘second power supply system’.

The plural PV systems 1 in the area are operated such as to be either of the power generation system 1a or the power generation system 1b. In the first embodiment, 50% of the PV systems 1 in the area operate as the power generation systems 1a, and the remaining 50% operate as the power generation systems 1b. Moreover, the PV systems 1 in the area interchange the power generation systems 1a and the power generation systems 1b at specific intervals (e.g. every month). In other words, as shown in FIG. 1, the area is divided-up into four sectors A, B, C and D, when the PV systems 1 in sectors B and D operate as the power generation system 1a, and the PV systems 1 in sectors A and C operate as the power generation systems 1b. Before and after the interchange of the threshold values (the interchange of the power generation systems 1a and the power generation systems 1b), the proportions of the power generation systems 1a and the power generation systems 1b do not change from the 50:50 ratio.

Hereafter, the state of FIG. 1 is referred to as the first state. Moreover, after the first state has been continued for one month, as shown in FIG. 2, the PV systems 1 in sectors B and D operate as the power generation systems 1b, and the PV systems 1 in sectors A and C operate as the power generation systems 1a. Hereafter, the state of FIG. 2 is referred to as the second state. In this manner, the first state and the second state follow each other on a one month repeat cycle.

Next, the PV systems 1 are described in detail.

The PV system 1 of embodiment 1, as shown in FIG. 3, not only provides the power generator 2 comprised of the solar cell generating power using sunlight, it also provides the battery 3 which is capable of storage of the power generated by the power generator 2, and the power output unit 4 including an inverter which outputs the power generated by the power generator 2 and the power stored by the battery 3 to the power grid 50, and the controller 5 controlling the charge and discharge of the battery 3. Moreover, load 60 is connected to the alternating current bus 6 connecting the power output unit 4 and the power grid 50.

The DC-DC converter 7 is connected in series on the direct current bus 6 connecting the power generator 2 and the power output unit 4. The DC-DC converter 7 converts the direct current voltage of the power generated by the power generator 2 to a fixed direct current voltage (In embodiment 1, approximately 260 V) and outputs to the power output unit 4 side. Moreover, the DC-DC converter 7 has a so-called a maximum power point tracking (MPPT) control function. The MPPT function is a function whereby the operating voltage of the power generator 2 is automatically adjusted to maximize the power generated by the power generator 2. A diode is provided (not shown in the figures) between the power generator 2 and the DC-DC converter 7 so as to prevent the reverse flow of the current to the power generator 2.

Moreover, the battery 3 includes the battery cell 31 connected in parallel with the DC bus 6, and the charge and discharge unit 32 which performs the electrical charge and discharge of the battery cell 31. As the battery cell 31, a rechargeable battery with high charge and discharge efficiency and low natural discharge (e.g. a lithium ion battery cell, a Ni-MH battery cell and the like) are employed. Moreover, the voltage of the battery cell 31 is approximately 48 V.

The charge and discharge unit 32 has a DC-DC converter 33, and the DC bus 6 and the battery cell 31 are connected via the DC-DC converter 33. When charging, the DC-DC converter 33 supplies electrical power from the DC bus 6 side to the battery cell 31 side by reducing the voltage of the DC bus 6 to a voltage suitable for charging the battery cell 31. Moreover, when discharging, the DC-DC converter 33 discharges the electrical power from the battery cell 31 side to the DC bus 6 side by raising the voltage from the voltage of the battery cell 31 to the vicinity of the voltage of the DC bus 6 side.

The controller 5 provides the memory 5a and the CPU 5b. The controller 5 performs the smoothing control of battery cell 31 by controlling the DC-DC convertor 33. Specifically, the controller 5 performs the charge and discharge of the battery cell 31 based on the power output of the power generator 2 (the power output of DC-DC convertor 7) and the later described target output value in order to compensate for the difference between the power output of the power generator 2 and the target output value. In other words, in the event that the power output by the power generator 2 is greater than the target output value, the controller 5 controls the DC-DC converter 33 to charge the battery cell 31 with the excess electrical power. In the event that the power output by the power generator 2 is less than the target output value, the controller 5 controls the DC-DC converter 33 to discharge the battery cell 31 to make up for the shortfall in the electrical power.

Moreover, the detection unit 8 is provided on the output side of the DC-DC converter 7, detecting the power generated by the power generator 2. The controller 5 enables the acquisition of the power output of the power generator 2 based on the outcome from the detection unit 8 at each of specific detection time intervals (e.g. not more than 30 seconds). Here, the power output data is acquired every 30 seconds by the controller 5 in the first embodiment. Now if the detection time interval of the power output data is too long or too short, the fluctuation in the power output cannot be detected accurately, it is set at an appropriate value in consideration of the fluctuation period of the power output of the power generator 2. In this embodiment, the detection time interval is set to be shorter than the lower limit period of the fluctuation period which the load frequency control (LFC) can deal with. The controller 5, recognizes the difference between the actual power output by the power output unit 4 to the power grid 50 and the target output value, by acquiring the output power of the power output unit 4. By this means, the controller 5 can control the electrical charging and discharging by the charge and discharge unit 32 such that the power output from the power output unit 4 becomes that of the target output value.

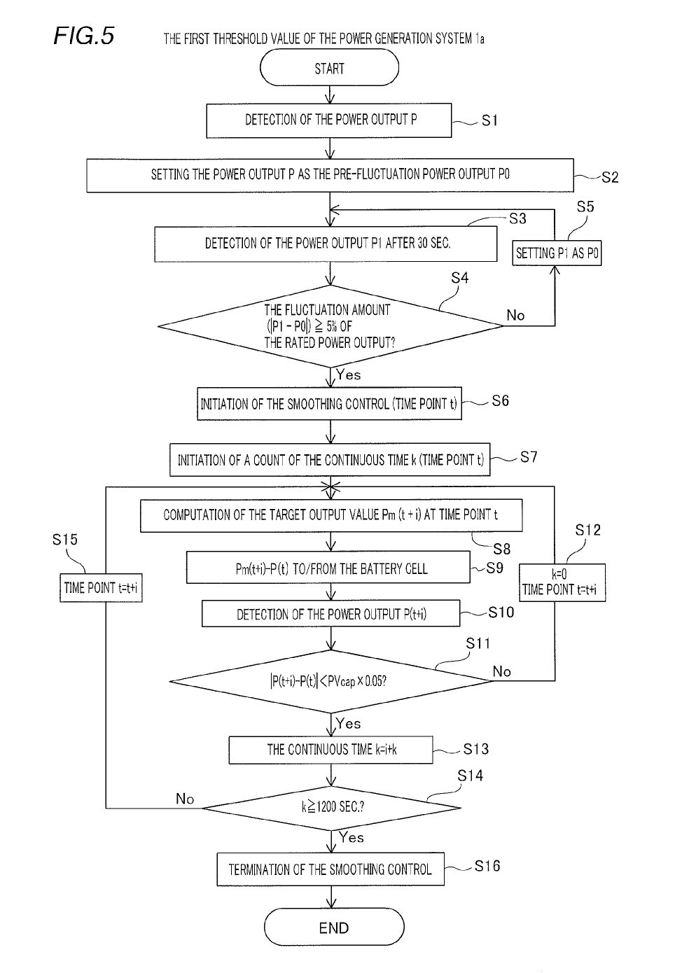

Moreover, the controller 5 computes the target output value for output to the power grid 50 using the moving average method. The moving average method is a computation method employing an average of the power generated by the power generator 2 in a period prior to a certain point as a target output value at the certain point, for example. The prior power output data was successively recorded in the memory 5a. Hereafter, the periods in order to acquire the power output data used in the computation of the target output value are called the sampling intervals. Now, the sampling period is but one example of the ‘first period’ in the present invention. The sampling period is between the lower limit period T2 and the upper limit period T1 of the fluctuation periods which load frequency control can deal with, in particular they are preferably in a range which does not span too long a time in the range from the vicinity of the latter half (The longer period vicinity) to over T1. As a specific example of the value for the sampling interval, for example, with power grids with ‘intensity of load fluctuation-fluctuation period’ characteristics as shown in FIG. 4, they are periods of not less than 10 minutes and not more than 30 minutes, and in the first embodiment, the sampling interval is set at approximately 20 minutes. In this situation, because the controller 5 acquires the power output data approximately every 30 seconds, the target output value is computed from the average value of 40 power output data samples in the last 20 minute interval. There is a detailed explanation provided later concerning this upper limit period T1 and the lower limit period T2.

In this manner, in the first embodiment, the PV system 1 does not output the generated power of the power generator 2, as is, to the power grid 50. In the first embodiment, the controller 5 computes the target output value from the past power output of the power generator 2, and controls the charge and discharge of the battery cell 31 in order that the total of the power output of power generator 2 and the amount of charge/discharge of the battery cell 31 becomes the target output value, and performs smoothing control such that the target output value is output to the power grid 50. By performing smoothing control, because the fluctuations in the power output to the power grid 50 are suppressed, the adverse impact on the power grid 50 of fluctuations caused by the presence or absence of clouds on the power output of the power generator 2 is suppressed.

Here, in the first embodiment, the controller 5 does not perform smoothing control all of the time, smoothing control is only performed when specific conditions are satisfied. In other words, the smoothing control is not performed when the output of the power generated by the power generator 2, as is, to the power grid 50 would not result in adverse effects on the power grid 50, and is configured such that smoothing control is only performed when the adverse effects would be great. Specifically, the smoothing control is configured to initiate in the event that the amount of fluctuation in the power generated by the power generator 2 is not less than a specific amount (hereafter referred to as “the control initiating fluctuation amount”). The controller 5, as the control initiating fluctuation amount, can select either of a first threshold value, or a second threshold value which is greater than the first threshold value. In the first embodiment, the controller 5 switches the size of control initiating fluctuation amount between the first threshold value and the second threshold value on every occasion of certain specific periods (e.g. one month).

When the PV system 1 operates as the power generation system 1a, the first threshold value is employed as the control initiating fluctuation amount. The first threshold value, for example, is a fluctuation amount which is greater than the maximum amount of fluctuation in a detection time interval in the midday time band of fine weather (cloudless sunny weather) when the weather is stable, and as a specific numerical value, 5% of the rated power output of the power generator 2 may be suggested. When the PV system 1 operates as the power generation system 1b, the second threshold value is employed as the control initiating fluctuation amount. The second threshold value, for example, is a value not less than two times of the first threshold value, and specifically, may be 15% of the rated power output of the power generator 2. The first threshold value and the second threshold value, as later described, may be statistically derived based on the data of the past power output. For example, the second threshold value, on days when the fluctuation of the power output is not very large, most of the values of the amount of fluctuation of the power output computed in a specific time interval are such that they do not exceed the set second threshold value. Now the ‘days when the fluctuation of the power output is not very large’ means that the weather on days when it is relatively stable'. Moreover, the amount of fluctuation in the power output involves the derivation computation of the difference between the power output data samples in two consecutive power output of a power generator 2 detected on each specific detection time interval.

Now in respect of the specific numerical values described above (5% and 15% of the rated power output of the power generator 2), the detection time interval of the power output is approximately 30 seconds and the like, which are the values corresponding to the first embodiment, when the detection time interval is changed, there is a need to reset the control initiating fluctuation amount in accordance with the detection time interval.

Moreover, after the initiation of the smoothing control, when the controller 5 determines that the fluctuation amount of the power output of the power generator 2 remains less than a specific amount (the control termination fluctuation amount), and when that state endures for more than a specific period (hereafter termed the ‘control terminating determination period’), the smoothing control is terminated where that state is sustained, and when not sustained, the smoothing control is continued until it is sustained. Here, the control termination determination period is a period which corresponds to a period where the load frequency control can deal with, and in the first embodiment, the upper limit period is set at 20 minutes. Moreover, the value of the control termination fluctuation amount is a value below the control initiating fluctuation amount, and in the first embodiment is set as to be the same value as the control initiating fluctuation amount. Therefore, when the PV system 1 operates as the power generation system 1a, 5% of the value of the rated power output of the power generator 2 is employed as the control termination fluctuation amount, when the PV system 1 operates as the power generation system 1b, 15% of the value of the rated power output of the power generator 2 is employed as the control termination fluctuation amount.

In other words, the controller 5, when performing smoothing control, the smoothing control is terminated when the state where the amount of fluctuation of the power output is less than 5% or 15% of the rated power output of the power generator 2 in continuity for 20 minutes. The detection of the fluctuation amount of the power output is performed every detection time interval (30 seconds), and the controller 5 performs a determination of whether the amount of fluctuation of the power output of the power generator 2 is less than 5% or 155 of the rated power output, or not, is also performed on each detection time interval (30 seconds). Therefore, when the computed amount of fluctuation in the power output, on each detection time interval, is less than 5% or 15% of the rated power output in continuity for 40 times (the control termination determination period of 20 minutes), the smoothing control is terminated. Now, as the control termination fluctuation amount of the power generation system 1a, 5% of the value of the rated power output of the power generator 2, and as the control termination fluctuation amount of the power generation system 1b, 15% of the value of the rated power output of the power generator 2, are each but examples, respectively, of the ‘third threshold’ and the ‘fourth threshold’ of the present invention. Moreover, the control termination determination period is but one example of the ‘second period’ of the present invention.

Next, the fluctuation period ranges of the performance of the main fluctuation controls by means of smoothing control in the first embodiment are explained.

As shown in FIG. 4, the control method which enabled a response to the fluctuation period is different and the load fluctuation periods which load frequency control (LFC) can deal with are shown in domain D (The domain shown shaded). Moreover, the load fluctuation periods which EDC can deal with are shown in domain A. Now domain B is a domain in which the load fluctuation can be absorbed naturally by the endogenous controls of the power grid 50. Furthermore, domain C is a domain which can be dealt with by the governor free operation of each of the power generators of the generating stations. Here, the load fluctuation period which can be dealt with by LFC at the border of domain D and domain A becomes the upper limit period T1, and the load fluctuation period which can be dealt with by load frequency control at the border of domain C and domain D becomes the lower limit period T2. The upper limit period T1 and the lower limit period T2 are not fixed periods in FIG. 3, but it can be appreciated that they are numerical values which vary with intensity of load fluctuations. In addition, the time of the fluctuation period shown in the figures will vary with the architecture of the power grid. For example, the value of the upper limit period T1 and the lower limit period T2 may vary due to the so-called run-in effect and the like. The degree of the run-in effect also varies with the prevalence and regional dispersibility of the PV system. In embodiment 1, the focus is on the fluctuation periods in the range of domain D (the domain which can be dealt with by LFC) which is the range where EDC, the endogenous control of the power grid 50 or the governor free operation cannot deal with, and the objective is to suppress them.

Next, an explanation is provided of the PV system 1 of the system when operating as the power generation system 1a while referring to FIG. 5.

Firstly, in step S1, the detection unit 8 detects the power output P of the power generator 2 in a specific time period. Then, in step S2, the controller 5 sets the power output P as the pre-fluctuation power output P0. Then, in step S3, the controller 5, acquires the power output in the 30 seconds after the detection of the power output P0 (The detection time interval), and sets that detected value as P1.

Thereafter in step S4, the controller 5 makes a determination as to whether the fluctuation amount in the power generated (|P1−P0|) is not less than the control initiating fluctuation amount or not (5% of the rated power output of the power generator 2). If the fluctuation amount in the power generated is less than the control initiating fluctuation amount, the controller 5 sets P1 as P0 in step S5 and acquires anew the value of P1 to monitor the fluctuation in the power generated in Step S3.

When the amount of fluctuation in the power output is not less than the control initiating fluctuation amount, in Step S6, the controller 5 initiates the smoothing control. In other words, the controller 5 controls the charge and discharge of the battery cell 31 so that the power from the power output unit 4 is output as a target output value which is the average of the power output in the last 20 minutes. In the following explanation, the starting point of the smoothing control is termed time point t.

Simultaneous with the initiation of the smoothing control (time point t), in step S7, the controller 5 initiates a count of the continuous time k where the amount of fluctuation of the power output is less than 5% of the rated power output of the power generator 2. Moreover, in step S8, the controller 5 computes in respect of the time point t, the power output from the power output unit 4 at time point t+i (i: the 30 seconds of the detection time interval) using the moving averages method (Target output value Pm (t+i)).

Next, in step S9, the controller 5 charges or discharges to/from the battery cell 31 the difference between the target output value Pm(t+i) and the power output P(t) (i.e. Pm(t+i)−P(t)). Now, when Pm(t+i)−P(t) is positive, the controller 5 charges to the battery cell 31, and discharges from the battery cell 31 when negative.

Then in step S10, when the time is t+i, the controller 5 detects the power output P(t+i) at time point t+i. Then, in step S11, the controller 5 makes a determination as to whether the fluctuation amount of the power output (The absolute value of the difference between the power output P(t+i) and the power output P(t)) is less than 5% of the rated power output PVcap of the power generator 2 (whether |P(t+i)−P(t)|<PVcap×0.05 is satisfied or not).

When |P(t+i)−P(t)|<PVcap×0.05 is not satisfied, the controller 5 not only sets the continuous time k to 0 in step S12, returns to step S8 after setting t=t+i. Moreover, if |P(t+i)−P(t)|<PVcap×0.05 is satisfied, in step S13, the controller 5 sets the continuous time k to k+i.

Thereafter in step S14, the controller 5 makes a determination as to whether the continuous time k is not less than 1200 seconds or not (When the control terminating determination period is 20 minutes). If the continuous time k is less than 1200 seconds, the controller 5, after setting time t=t+i in step S15, returns to step S8, and repeats steps S8˜S15 until the continuous time k becomes not less than 1200 seconds. When the continuous time k is not less than 1200 seconds, the controller 5 terminates the smoothing control in step S16.

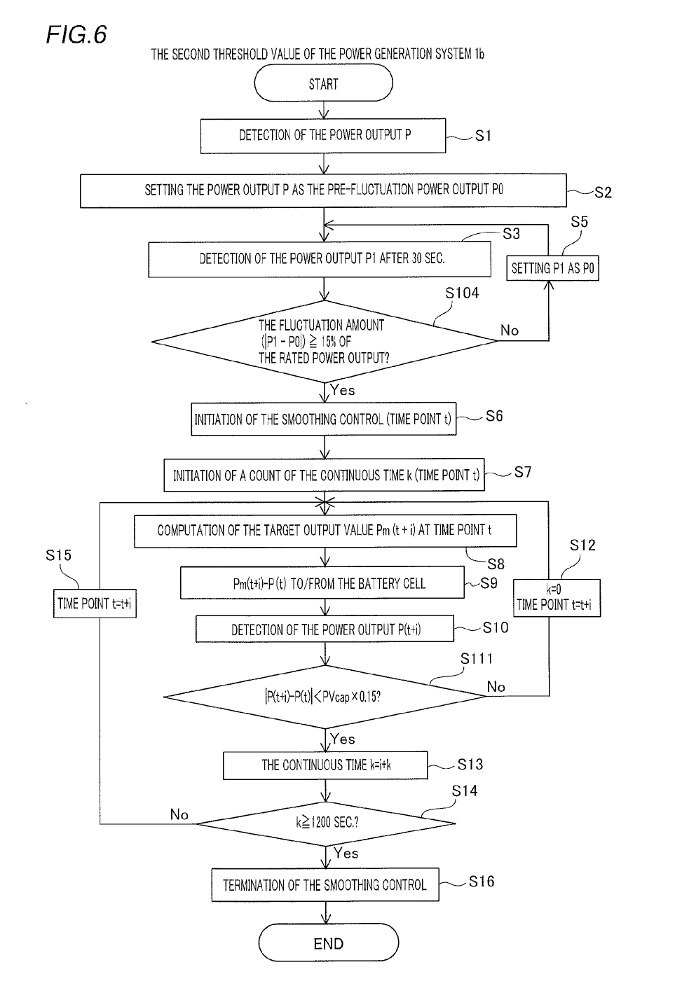

Moreover, when the PV system 1, of the stabilization system of embodiment 1 operates as the power generations system 1b, the control flow is as shown in FIG. 6, and other than the threshold value of step S104 and step S111 being changed from that in step S4 and step S11, it is the same as the control flow of the power generation system 1a. In the power generation system 1b, in step S104 the controller 5 has 15% of the rated power output of the power generator 2 as the threshold value, and performs the determination as to whether to initiate smoothing control. Moreover, in step S111, the controller 5 has 15% of the rated power output of the power generator 2 as the threshold value, and performs the determination of whether to terminate the smoothing control.

The stabilization system of embodiment 1 derives the following benefits by means of the configuration described above.

In other words, the PV systems 1 of the stabilization system includes the power generation systems 1a initiating the smoothing control when the amount of fluctuation of the generated power is not less than the first threshold value, and the power generation systems 1b initiating the smoothing control when the value of the detected power is not less than the second threshold value, a value that is greater than the first threshold value, in the area. By this means, when the power generation systems 1a set the base as the first threshold value, because the power generation systems 1b initiating the smoothing control using the second threshold value enable the reduction in the amount of charge and discharge, when the overall area is looked at in its entirety, a contrivance at the lengthening of the lifetime of the batteries 3 in the area is enabled.

Moreover, the second threshold value is set to be two or more times greater than the first threshold value. By this means, a large reduction in the amount of charge and discharge of the battery 3 in the overall area and the number of charge and discharge events is enabled.

Furthermore, the PV systems 1 switch over between the first threshold value and the second threshold value after specific periods (for example one month). In that situation, unlike when the PV systems 1 (the generation system 1a) are fixed to employ the first threshold value and the PV systems 1 (the generation system 1b) are fixed to employ the second threshold value, the lengthening of the lifetime of the battery 3 of a specific PV system 1 is not enabled, a contrivance at the uniform lengthening of the lifetime in respect to all of the PV system in the overall area is enabled.

Moreover, the detection time interval is set at a period which is less than the lower limit period of the fluctuation periods which the load frequency control can deal with. By acquiring the power output in these type of detection time intervals, the fluctuations in the power output having fluctuation periods which the load frequency control can deal with is more easily enabled to be detected. By this means, the performance of smoothing control is enabled such that a reduction in the fluctuation components of the fluctuation periods which the load frequency control can deal with is enabled.

Furthermore, the sampling periods are set to periods which are above the lower limit period of the fluctuation periods which the load frequency control can deal with. By enabling charge and discharge control such that the target output value is computed in this type of sampling period range, in particular, enables a reduction in the components of the fluctuation periods which the load frequency control can deal with. By this means, the effective suppression of adverse effects on the power grid 50 is enabled in the range of fluctuation periods which the load frequency control can deal with.

Moreover, the power generation systems 1a and the power generation systems 1b initiate smoothing control in the event that the amount of fluctuation of the power output become not less than the first threshold value (5% of the rated power output) and not less than the second threshold value (15% of the rated power output), respectively, and when a situation where the values in respect to the detected power output are less than the first threshold value (5% of the rated power output) and less than the second threshold value (15% of the rated power output), respectively, continues for a period (20 minutes), the smoothing control is terminated. By means of this type of configuration, because the termination of smoothing control is enabled when smoothing control is not required as the power output is low, the amount of charge and discharge of the battery 3 and the number of charge and discharge events can be reduced. By this means, a further contrivance at the lengthening of the lifetime of the battery 3 is enabled.

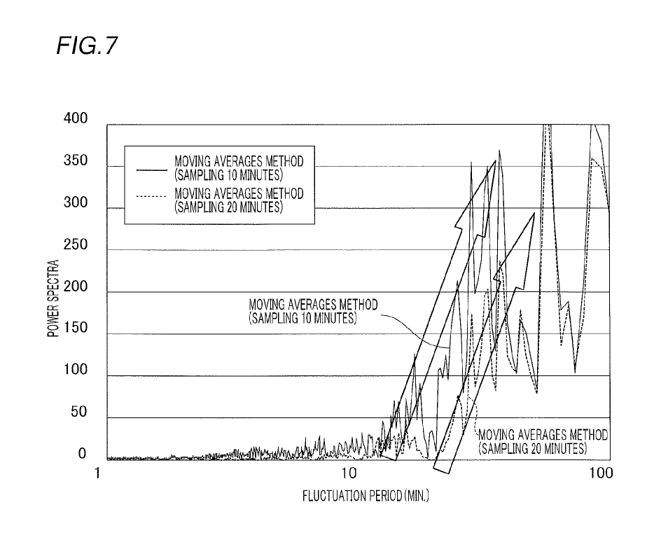

Next, the sampling period of the moving averages method is investigated. FIG. 7 shows the results of the FFT analysis of the power output data when the sampling period which is the acquisition period of the power output data was 10 minutes, and the results of the FFT analysis of the power output data when the sampling period was 20 minutes.

As shown in FIG. 7, when the sampling period was 10 minutes, while the fluctuations in respect of a range of up to 10 minutes of a fluctuation period could be suppressed, the fluctuations in a range of fluctuation periods which were not less than 10 minutes were not suppressed well. Moreover, when the sampling period was 20 minutes, while the fluctuations in respect of a range of up to 20 minutes of a fluctuation period could be suppressed, the fluctuations in a range of fluctuation periods which were not less than 20 minutes was not suppressed well. Therefore, it can be understood that there is a good mutual relationship between the size of the sampling period, and the fluctuation period which can be suppressed by the smoothing control. For this reason, it can be said that by setting the sampling period, the range of the fluctuation period which can be suppressed effectively changes. In that respect, in order to suppress parts of the fluctuation period which can be addressed by the load frequency control which is the main focus of this system, it can be appreciated that in order that sampling periods which are not less than the fluctuation period corresponding to what the load frequency control can deal be set, in particular, it is preferable that they be set from the vicinity of the latter half of T1˜T2 (The vicinity of longer periods) to periods with a range not less than T1. For example, in the example in FIG. 4, by utilizing a sampling period of not less than 20 minutes, it can be appreciated that suppression of most of the fluctuation periods corresponding to the load frequency control is enabled. However, when the sampling period is made longer, there is a tendency that the required battery capacity grows large, and it is preferable to select a length of sampling period which is not much longer than T1.

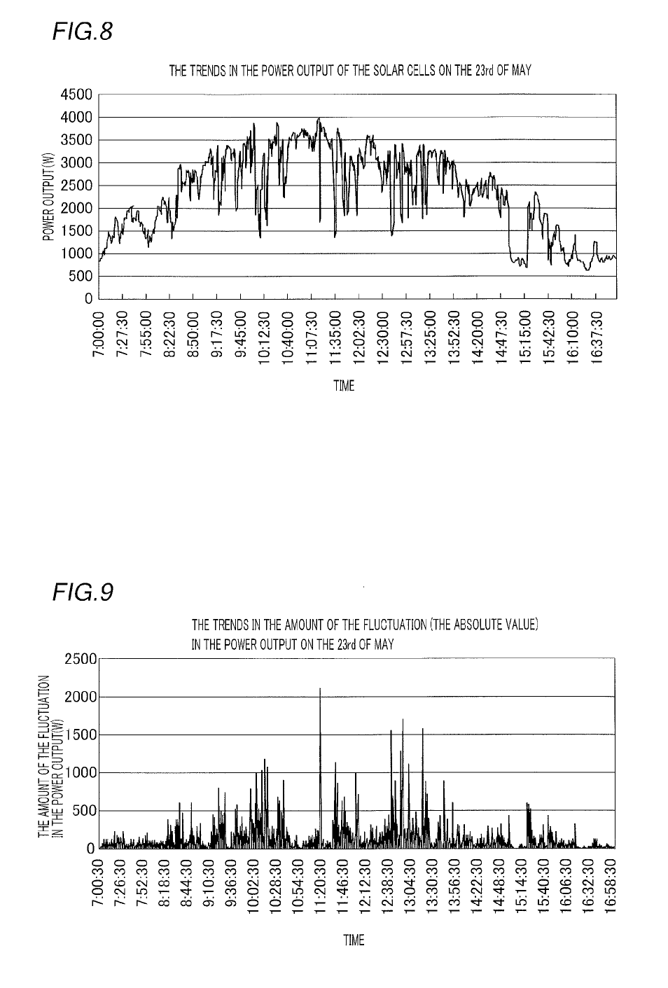

Next, a detailed explanation is provided of the results of a simulation to investigate the effectiveness of using the power supply system 1 while referring to FIGS. 8˜25.

FIG. 8˜FIG. 19 show the trends of the amount of the fluctuation of the power output and the trends of the power output on days when the fluctuations of the power output were severe and moderate in February, May and August. Days when there were severe fluctuations in the power output are days when there are repeated occurrences of fluctuations in the power output, days when there were moderate fluctuations in the power output are days when there were hardly any continuous fluctuations in the power output. The data in FIG. 8˜FIG. 19 are based on actual amount of sunlight data measured in Saitama Prefecture in 2009, and are the simulation results of the power output when a solar cell having a rated power output of 4 kW was used. Moreover, while not represented in this specification, simulations were also performed in respect to days other than those in FIG. 8˜FIG. 19.

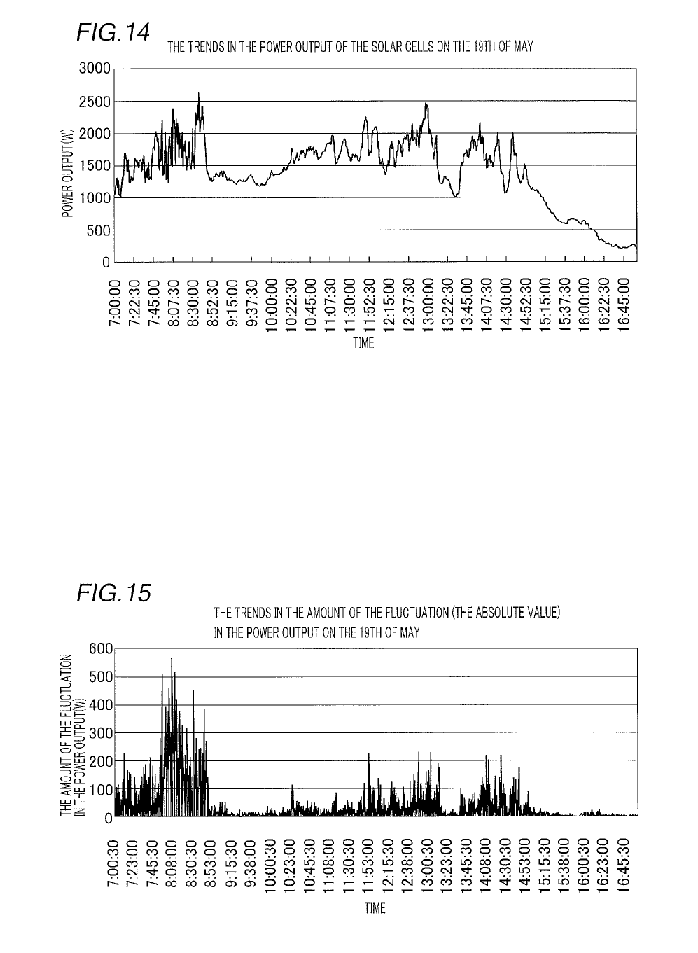

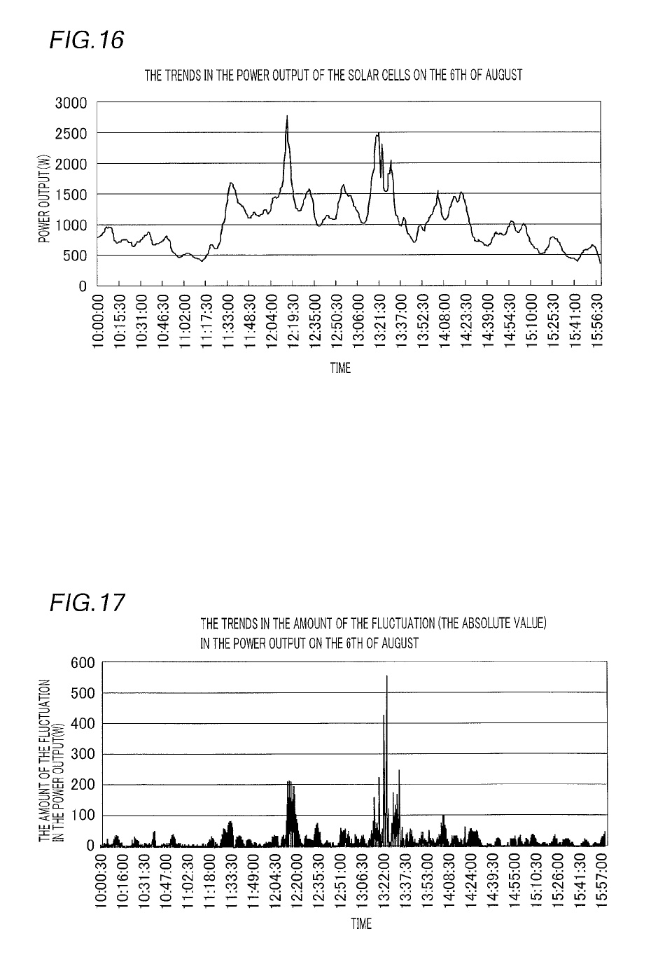

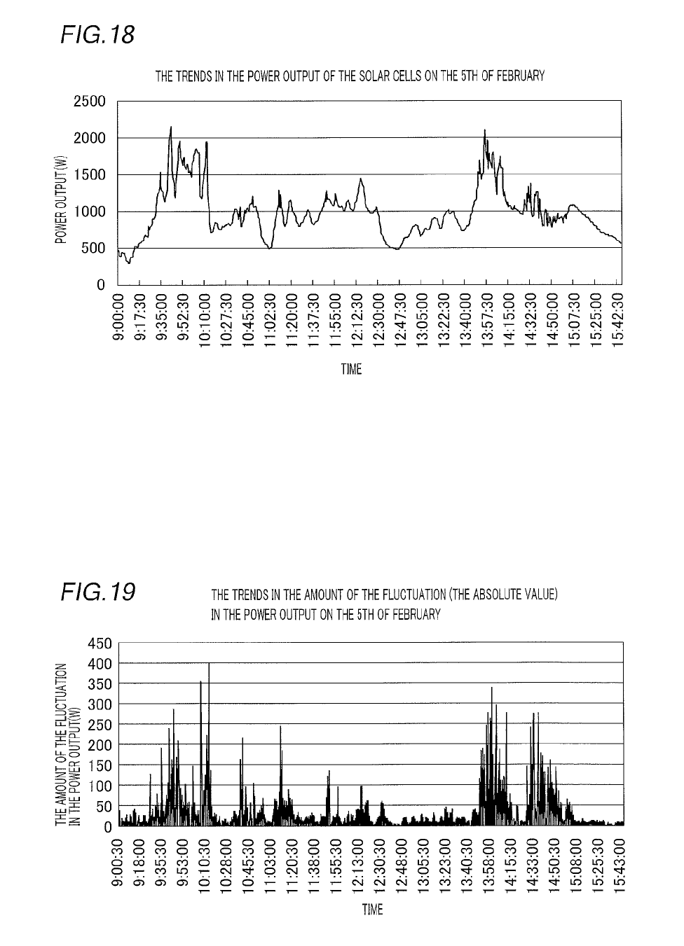

Firstly, on a May day when the amount of fluctuation was relatively mild (for example on the 19^{th} of May as shown in FIG. 14 and FIG. 15), the amount of fluctuation of the power output was mainly in the 5%˜10% of the rated power output range (200 W˜400 W) and parts thereof the amount of fluctuation is in the 10%˜15% of the rated power output range. Moreover, in respect to August days when the amount of fluctuation was relatively moderate (for example the 6^{th} of August as shown in FIG. 16 and FIG. 17) the amount of fluctuation in the power output was concentrated mainly in the 5%˜10% of the rated power output range, and even when there were relatively large fluctuations, the amount of fluctuation was less than 15% of the rated power output. Furthermore, on February days when the fluctuations were relatively moderate (for example, on the 5^{th} of February as shown in FIG. 18˜FIG. 19), the amount of fluctuation of the power output was 10% (400 W) of the rated power output at most.

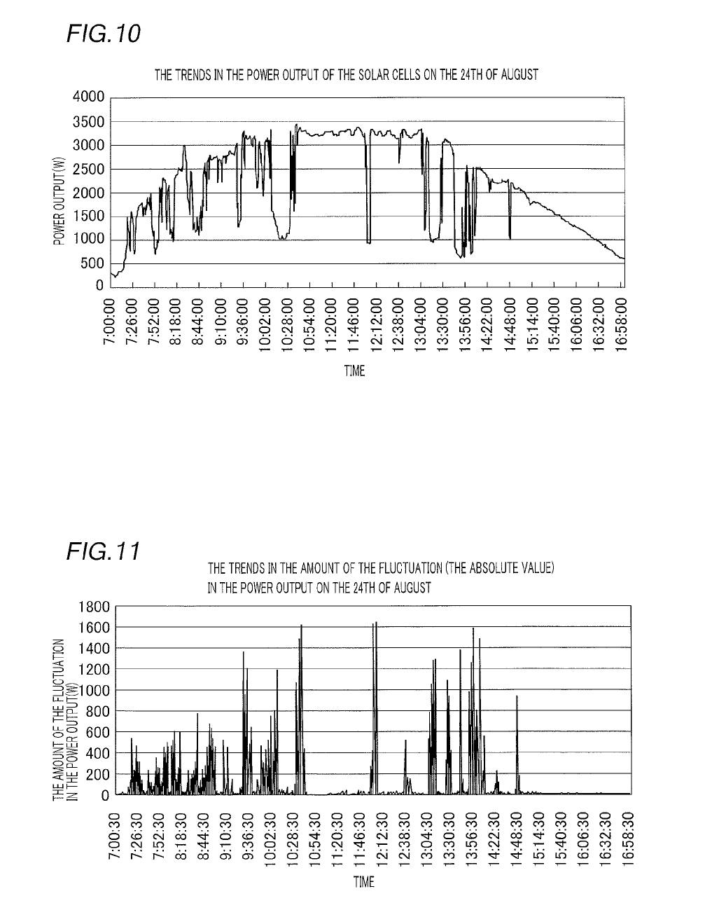

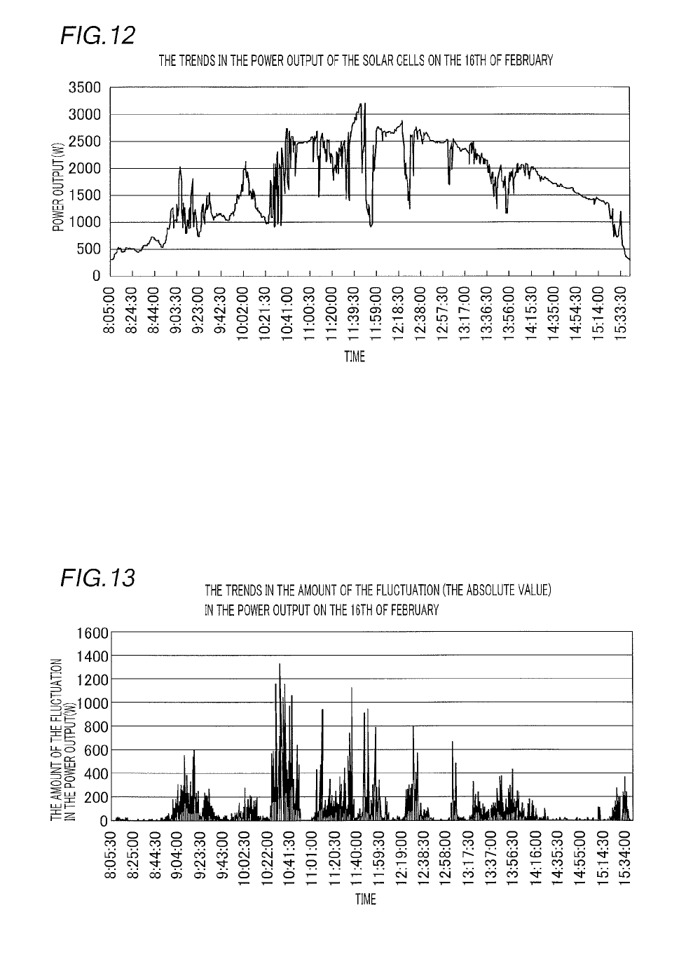

On the other hand, in respect to a May day, when the amount of fluctuation was relatively severe (for example the 23^{rd} of May as shown in FIG. 8 and FIG. 9) days when the fluctuation of the power output exceeded 20% (800 W) of the rated power output were days with severe fluctuation. Moreover, in respect to August days when the amount of fluctuation was relatively severe (for example on the 24^{th} of August as shown in FIG. 10 and FIG. 11) days when the fluctuation of the power output exceeded 25% (1000 W) of the rated power output were days with severe fluctuation. Furthermore, in respect to February days when the amount of fluctuation was relatively severe (for example on the 16^{th} of February as shown in FIG. 12 and FIG. 13) days when the fluctuation of the power output exceeded 15% (600 W) of the rated power output were days with severe fluctuation.

From the analysis results of the type shown above, if the fluctuation amount of the generation power output is less than 15% of the rated power output, it can be appreciated that the fluctuations on that day were mild, and the amount of fluctuation could also be expected to be small. Therefore, by setting the second threshold value to be not less than 10% and not more than 20% of the rated power output, on days when the fluctuations in the power output were large, by operating the second threshold value, effective smoothing for the entire area can be derived, and on days when the fluctuations in the power output are small, by not operating the second threshold value, and by operating the first threshold value, effective smoothing for the entire area can be derived. Now, in embodiment 1 of the present invention the first threshold value was determined to be 5% of the rated power output, and the second threshold value was determined to be 15%.

Next, in respect of the trends of the power output shown in FIG. 8 FIG. 19 (19^{th} of May, 23^{rd} of May, 6^{th} of August, 24^{th} of August, 5^{th} of February and 16^{th} of February) simulations of the amount of charge and discharge of the battery 3 for the stabilization system of the embodiment and the stabilization system of the comparative example are compared.

Now, in these simulations as the stabilization system of the embodiment, of the two PV systems 1, one of them employed the first threshold value (5% of the rated power output) in performing the determination of the initiation of smoothing in the power generation system 1a, the other one employed the second threshold value (15% of the rated power output) in performing the determination of the initiation of smoothing in the power generation system 1b. Moreover, the stabilization system of the comparative example, of the two PV systems 1, both of them employed the first threshold value (5% of the rated power output) in performing the determination of the initiation of smoothing in the power generation system 1a. These simulation results are shown in Table 1 below. Now, the amount of charge and discharge is that of one device.

TABLE 1
The amount of charge and discharge (Wh) for one device

| | Severity of fluctuation | | | | | |
|---|---|---|---|---|---|---|
| | May | | August | | February | |
| | Moderate | Severe | Moderate | Severe | Moderate | Severe |
| | (19^{th} of | (23^{rd} of | (6^{th} of | (24^{th} of | (5^{th} of | (16^{th} of |
| | May) | May) | August) | August) | February) | February) |
| Comparative | 1466 | 3072 | 971 | 3654 | 1052 | 1641 |
| example | | | | | | |
| Embodiment | 733 | 2934 | 486 | 3456 | 526 | 1600 |

As shown in Table 1 on days when the amount of fluctuation was moderate (19^{th} of May, 6^{th} of August and 5^{th} of February) the amount of charge and discharge of the embodiment was approximately half that of the comparative example, and it can be appreciated that the reduction effect on the amount of charge and discharge can be great. This was because, on days when the fluctuation was relatively moderate, because the fluctuations of the generated power in excess of the second threshold value (15% of the rated power output), in the power generation system 1b, of the two devices performing the determination on the initiation of the smoothing control using the second threshold value, there was no period of performance of the smoothing control.

Now, when the fluctuations in the power output were not very large, the smoothing control of the power generation system 1b was not performed, but looking at the overall area, sufficient smoothing of the power output was enabled.

In contrast to this, on days when the fluctuations were relatively severe (23^{rd} of May, 24^{th} of August and 16^{th} of February) it can be appreciated that the amount of charge and discharge did not vary much between the embodiment and the comparative example. This was because, on days when the fluctuations were relatively severe, when the fluctuations in the power output exceed the first threshold value, because fluctuations of the power output exceeding the second threshold value were generated soon thereafter, the timing of the initiation of the smoothing control in the embodiment and in the comparative example did not vary very much.

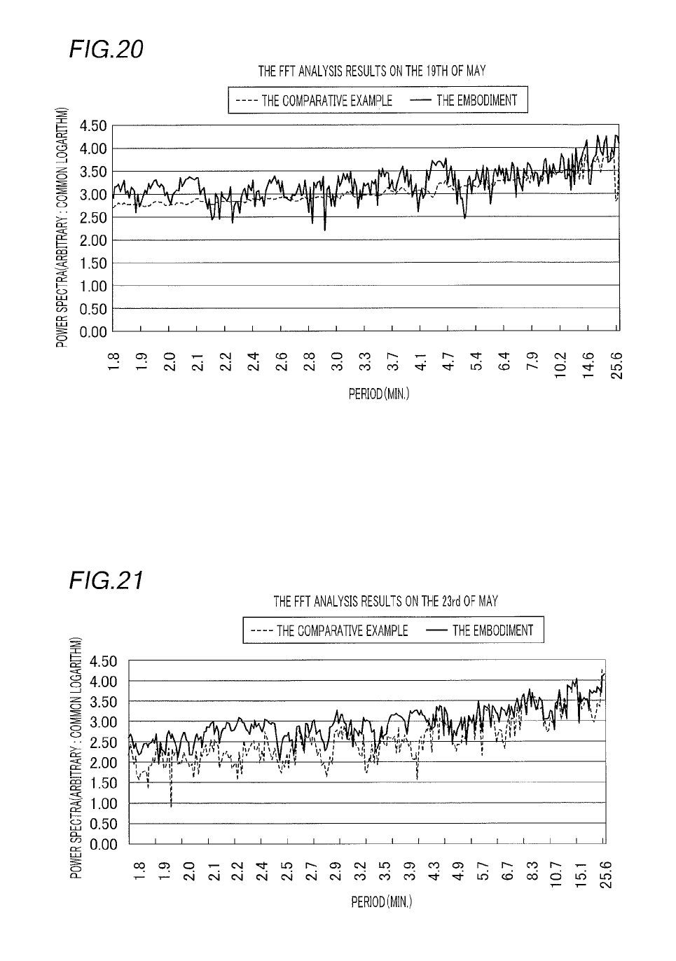

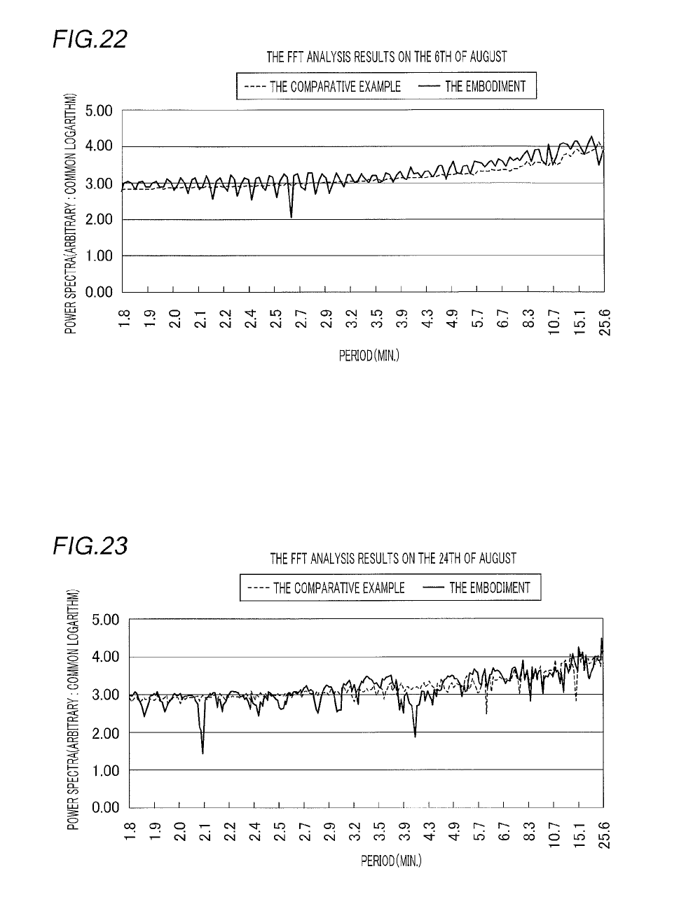

Next, in respect of the trends of the power output shown in FIG. 8 FIG. 19 (19^{th} of May, 23^{rd} of May, 6^{th} of August, 24^{th} of August, 5^{th} of February and 16^{th} of February), FFT (fast Fourier transformation) analysis in respect to the power output when the smoothing control of the embodiment was performed, and FFT analysis in respect to the power output when the smoothing control of the comparative example was performed. Those analysis results are shown in FIG. 20˜FIG. 25 and in Table 2 below.

TABLE 2
FFT analysis results (comparison of the power
spectra in 2~20 minute fluctuation periods)

| | Severity of fluctuation | | | | | |
|---|---|---|---|---|---|---|
| | Moderate | Severe | Moderate | Severe | Moderate | Severe |
| | (19^{th} of | (23^{rd} of | (6^{th} | (24^{th} of | (5^{th} of | (16^{th} of |
| | May) | May) | August) | August) | February) | February) |
| Comparison | Almost no | Almost no | No | No | The | No |
| of the | difference | difference | difference | difference | embodiment | difference |
| embodiment | | | | | was slightly | |
| and the | | | | | larger | |
| comparative | | | | | | |
| example | | | | | | |

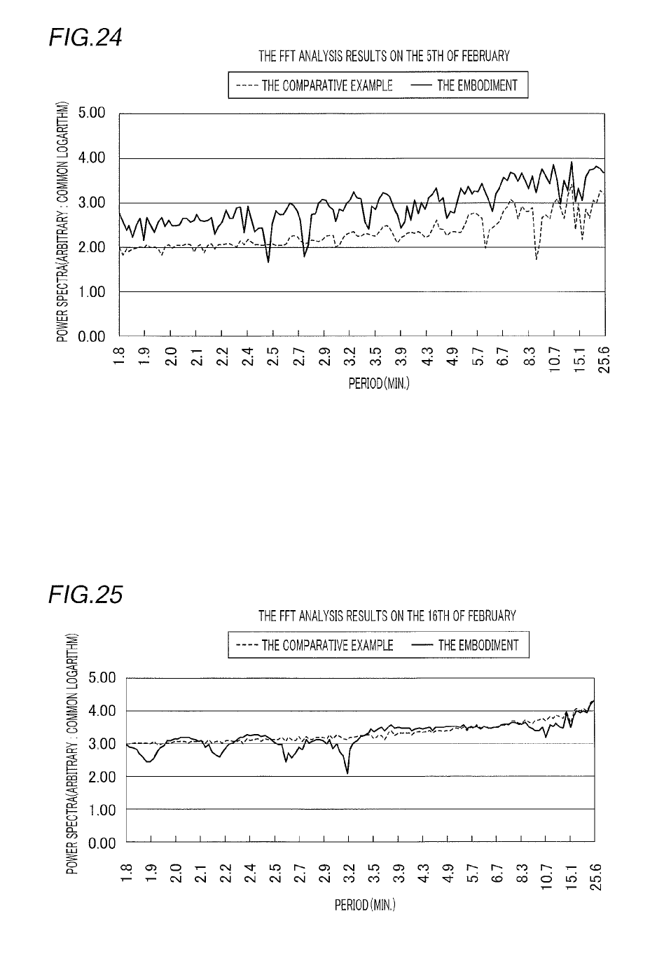

As shown in FIG. 24 and Table 2, while the power spectra of the embodiment on the 5^{th} of February was slightly larger than that of the comparative example, because the amount of fluctuation of the power output as small as 10% of the rated power output at its maximum, it can be considered that the impact on the power grid was low. Other than on the 5^{th} of February, it can be appreciated from FIG. 20˜FIG. 23, FIG. 25 and Table 2 that there was almost no difference between the embodiment and the comparative example. In other words, it can be appreciated that in the embodiment and in the comparative example substantially the same level of the suppression of the fluctuations of the power output were enabled.

Now, in these simulations, a model was employed where there were two PV systems in the area, but even when even more PV systems are installed in the area by setting an appropriate second threshold value, it is considered that a reduction in the amount of charge and discharge overall may be achieved while suppressing the fluctuations of the power output at substantially the same level as in the comparative example. Moreover, in the embodiment, the second threshold was determined to be 15% of the rated power output based on the trends of the power output of one PV system in the past, but when the entirety of a wide area of the type managed by a power company is considered, there is a natural suppression of the fluctuations of the power output of individual PV systems as a result of the so-called run-in effect. In that situation in consideration of the run-in effect even when the second threshold value is set at a value greater than 15% of the rated power output, it is considered that a reduction in the amount of charge and discharge overall may be achieved while suppressing the fluctuations of the power output at substantially the same level as in the comparative example.

As described above, the inventors discovered that by setting the second threshold value to an appropriate size, even when the power generation systems 1b, determining the initiation smoothing control by means of the second threshold value, which is greater than the first threshold value, were installed in the area, the performance of substantially the same level of smoothing control (the suppression of the fluctuations of the power output to the power grid 50) as when all of the PV systems 1 had the first threshold value was enabled.

Moreover, when there were fluctuations in the power output between the first threshold value and the second threshold value, in the power generation systems 1b which performed the determination of the initiation of the smoothing control using the second threshold value did not initial smoothing control, but even in this type of situation, substantially the same level of smoothing of the fluctuations of the power output as was achieved in stabilization systems comprised only of the power generation systems 1a performing the determination of the initiation of smoothing control using the first threshold value was enabled. Furthermore, in power generation system 1b because the smoothing control periods are shorter in proportion to the larger size of the threshold value, a reduction in the amount of charge and discharge and the charge and discharge occasions of the battery 3 in the area overall was enabled, and as a result a contrivance at the lengthening of the lifetime of the battery 3 was enabled.

### Embodiment 2

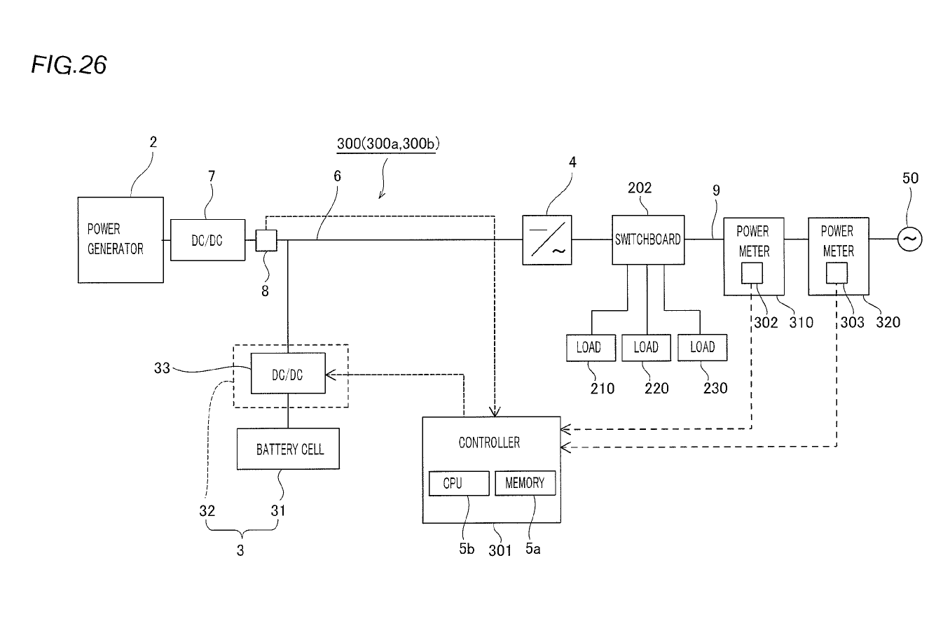

Next, an explanation is provided of the systems stabilization system by means of the second embodiment of the present invention while referring to FIG. 26. In the first embodiment, an example was represented were the smoothing control was performed based on the power output of the power generator 2. On the other hand, in this second embodiment, an example is explained where smoothing control is performed based on the input and output power (the power purchase or the power selling) between the PV system 300 and the power grid 50.

As shown in FIG. 26, the PV systems 300 employed in the stabilization system of the second embodiment provide the power generator 2, the battery 3, the power output unit 4, the controller 301, the DC-DC convertor 7 and the detection unit 8. Moreover, the three loads 210, 220 and 230 are connected to the alternating current bus 9, via the switchboard 202, between the power output unit 4 and the power grid 50.

Furthermore, the power meter 310 measuring the power selling to the power grid 50 from the power supply system 300 and the power meter 320 measuring the power purchase from the power grid 50 are provided on the power grid 50 side of the switchboard 202 of the alternating current of bus 9. The power sensor 302 and the power sensor 303 are provided, respectively, on the power meter 310 and the power meter 320.

The controller 301 enables the acquisition of the input and output power data (the power purchase data or the power selling data) between the PV system 300 and the power grid 50 based on the output of the power sensors 302 and 303 on a specific detection time interval (for example, not more than 30 seconds). The controller 301 acquires the value of the power selling minus the power purchase as the input and output power data (the power purchase data or the power selling data) between the PV system 300 and the power grid 50. Moreover, the controller 301 computes the target output value based on the past detected power output data, and performs charge and discharge of the battery cell 31 in order to compensate for the difference between the target output value and the actual detected power output. In other words, when the actual detected power output is greater than the target output value, the controller 301 controls the DC-DC convertor 33 in order to charge the battery cell 31 with the excess power, and when the actual detected power output is less than the target output value, the controller 301 controls the DC-DC convertor 33 in order to discharge the shortfall power from the battery cell 31.

The PV system 300 operates as the power generation system 300a determining the initiation of smoothing control by means of a small threshold value (the first threshold value), and as the power generation system 300b determining the initiation of smoothing control by means of the second threshold value which is larger than the first threshold value. Now, the power generation systems 300a and 300b, respectively, are examples of the “first power supply system” and the “second power supply system”.

Furthermore, the controller 301, just as in embodiment 1 described above, as the control initiating fluctuation amount can select either of the first threshold value (for example 5% of the rated power output) and the second threshold value (for example 15% of the rated power output). In the second embodiment, the controller 5, changes the size of the control initiation fluctuation amount between the first threshold value and the second threshold value on every occasion of the specific period described above (for example 1 month). When the PV systems 300 operates as the power generation systems 300a, the first threshold value can be used as the control initiating fluctuation amount. When the PV systems 300 operates as the power generation systems 300b, the second threshold value can be used as the control initiating fluctuation amount.

In regard to the configuration of the second embodiment, other than that described above it is the same as that of embodiment 1 described above.

In embodiment 2, because there are plural loads (the loads 210, 220 and 230) prepared, the fluctuation in the amount of the load in respect of the total load is great. The detection by means of by the power sensor 302 and the power sensor 303 enables the reflection of the value of the load, more than the detection by means of the detection unit 8. By performing smoothing based on these values reflecting the load, the effective performance of the smoothing is enabled.

Now, in the embodiments and examples disclosed here, it should be considered that all points were for the purposes of illustration and the invention is not limited to those points. The scope of the present invention is not defined by those embodiments explained but by the scope of the claims of the invention, and in addition, all equivalent meaning to the scope of the claims and all modifications within the range of the scope of the claims are included in the invention.

For example, in the first and second embodiments described above, examples were described where solar power cells were employed as the power generator 2 but the present invention is not limited to these, and power generators employing renewable energy such as wind power generators and the like may be employed.

Moreover, in embodiments 1 and 2 described above, examples were shown where lithium ion batteries or Ni-MH batteries were employed as the battery cells, but the present invention is not limited to these, and other rechargeable batteries may be employed. Moreover, as one example of the ‘battery, a capacitor may be employed instead of the battery cell.

In the embodiments 1 and 2 and the examples described above, an explanation was provided whereby the voltage of the battery cell 31 is 48 V, but this invention is not limited to this, and can be a voltage other than 48 V. Now, it is desirable that the voltage of the battery cell is not more than 60 V.

Furthermore, in the embodiment 1 described above, an explanation was provided whereby the power consumption in the consumer home was not taken into consideration in the load in the consumer home, but this invention is not limited to this, and in the computation of the target output value, a power is detected wherein at least part of the load is consumed at the consumer location, and the computation of the target output value may be performed considering that load consumed power output or the fluctuation in the load consumed power output.

Moreover, in the present invention, in regard to the specific numerical values for the sampling periods, bus voltages and the like they are not limited to the numerical values disclosed in embodiments 1 and 2 described above and may be modified as appropriate.

Furthermore, in embodiment 1 described above, an example was explained where the difference between the target output value and the power output at the output time point of the target output value was used as the index but the present invention is not limited to this, and the difference between the target output value and the power output at one detection time interval earlier (30 seconds) than the output time point of the target output value, and the like, the difference between the target output value and the power output at a time point in the vicinity of the output time point of the target output value may be employed as the index.

Moreover, in the embodiments 1 and 2 described above an example was explained where the control terminating determination period corresponds to the fluctuation periods which the load frequency control can deal with (not less than the lower limit period T2 and not more than the upper limit period T1), but the present invention is not limited to this, and they may be greater than the upper limit period T1 or less than the lower limit period T2.

Furthermore, in the embodiments 1 and 2 described above an example was explained where the smoothing control was initiated when the fluctuation amount of the power output was in excess of the control initiated fluctuation amount, but the present invention is not limited to this, a determination may be performed to initiate smoothing control based on the value of the power output itself.

Moreover, in the embodiments 1 and 2 described above examples were explained whereby the determination of the initiation of the smoothing control employed two threshold values (the first threshold value and the second threshold value) for the PV systems in the area, but the present invention is not limited to these, and the performance of the determination of the initiation of the smoothing control may employ three or more threshold values. Even in that situation, in order to derive a uniform reduction effect in the amount of charge and discharge in the area, it is preferable that the three threshold values described above are mutually replaced on specific time intervals.

Furthermore, in the embodiments 1 and 2 described above an example was explained where the proportion of the power generation systems 1a using the first threshold value to the power generation systems 1b using the second threshold value was 50%:50%, the present invention is not limited to these, and a different proportion may be employed. Therefore, by enabling the increase of the proportion of the power generation systems 1b in accordance with the size of the fluctuations, the reduction in the amount of charge and discharge of the battery over the whole area is enabled.

Moreover, in the embodiments 1 and 2 examples were explained where the first threshold value was set as 5% of the rated power output and the second threshold value was set as 15% of the rated power output, but the present invention is not limited to these, and other values may be employed. It is conceivable that depending on the differences in the climate and the amount of sunlight, the appropriate second threshold value may be different.

Furthermore, in embodiments 1˜3 described above examples were explained where the control terminating fluctuation amount and the control initiating fluctuation amount were the same value, but this invention is not limited to these, and the control terminating fluctuation amount may be smaller than the control initiating fluctuation amount.

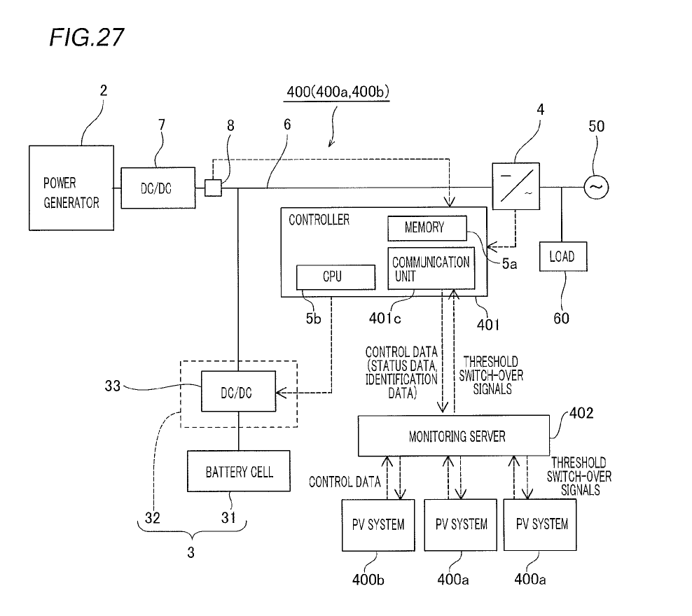

Furthermore, in embodiment 1 described above, an example was explained where the PV system 1 was configured to switch over between a first and second threshold value at specific time intervals, but the present invention is not limited to these. For example, as shown in the modified embodiment shown in FIG. 27, the communication unit 401c of the controller 401, when a signal is input from the monitoring server 402 to switch-over between the first threshold value and the second threshold value, then the switch-over between the first threshold value and the second threshold value may be enabled in this manner. The monitoring server 402 acquires the status data of plural PV systems 400 by performing communication therewith via the communication unit 401c, and thus monitors the status thereof. By this means, the interchange between the PV systems 400 controlled by means of the first threshold value (the power generation systems 400a) and the PV systems 400 controlled by means of the second threshold value (the power generation systems 400b) is enabled simply and well. Here, the status data is data showing the status data of the battery cells including the power generation system, and comprises, for example, the State of Charge, number of cycles and data on deterioration. The status data is has identification information to specify the individual PV systems 400. Then, the control data including the status data and the identification data is sent from each PV system 400 to the monitoring server 402. Moreover, threshold switch-over signals including threshold data setting the new thresholds are transmitted from the monitoring server 402 to each PV system 400.

The monitoring server 402 can also set the threshold value of each PV system 400 from the number of cycles of the battery cells and the status information on the deterioration thereof. Specifically, the threshold values of PV systems including battery cells whose deterioration has progressed beyond a specific standard may be set higher (the second threshold value), and the threshold values of PV systems including battery cells with no deterioration may be set lower (the first threshold value). In addition, the monitoring server 402 may adjust the switch-out period of the threshold values for deteriorated battery cells such that the period of operation of the second threshold value (for example one month) to be longer than the operational period of the first threshold value (for example, 2 weeks). Conversely, the monitoring server 402 may adjust the switch-out period of the threshold values for lesser deteriorated battery cells such that the period of operation of the first threshold value (for example two weeks) to be longer than the operational period of the first threshold value (for example, one month). By this means, because the charge and discharge of deteriorated batteries can be suppressed, the lifetime of the battery cells can be lengthened.

1. A stabilization system providing plural power supply systems, the power supply systems comprising:
distributed type power sources, and detection unit detecting the power passing through specific parts of the distribution lines between the distributed type power sources and the power grid,
wherein smoothing control is performed on the power output to the power grid based on the detected power output data of the detection unit, and the plural power supply systems include a first power supply system performing smoothing control in the event that the amount of fluctuation of the value of the detected power output is not less than a first threshold value, and a second power supply system performing smoothing control in the event that the amount of fluctuation of the value of the detected power output is not less than a second threshold value which is greater than the first threshold value.

2. The stabilization system of claim 1, wherein the stabilization system also has in addition a master management device performing communication between the first and the second power supply systems, the first and second power supply system additionally have communication device enabling communication with the master control system, and control data corresponding to the identification information in order to specify the power supply systems and distributed power sources data showing the state of the distributed type power sources is transmitted to the master management device via the communications device, in addition to at least one of the first threshold value and the second threshold value being received from the master management device.

3. The stabilization system of claim 1, wherein the second threshold value is two or more times greater than the first threshold value.

4. The stabilization system claimed of claim 1, wherein the second threshold value is not less than 10% and not more than 20% of the rater power output value of the distributed type power sources of the second power supply system.

5. The stabilization system claimed of claim 1, wherein the first power supply system and the second power supply system control as the second power supply system and the first power supply system respectively, by interchanging the first threshold value and the second threshold value.

6. The stabilization system of claim 1, wherein the stabilization system acquires the detected power output data of the detection unite on specific detection time intervals, and is configured to compute a target output value for output to the power grid by a moving averages method on acquiring the detected power output data over the range of a specific first period, when the smoothing of the power output to the power grid is performed.

7. The stabilization system of claim 1, wherein in the first power supply system and the second power supply system smoothing control is terminated when the values of the detected power output during the performance of smoothing control are in a state where they are not more than the first threshold value at less than a specific third threshold value, and not more than the second threshold value at less than a specific fourth threshold value for a specific second period in continuity.

8. The stabilization system of claim 1, wherein when a load is connected to the distribution line between the power grid and distributed type power sources, the detection unit is configured to detect the power leaving and entering the power grid from the power grid side of the part of the load connected to the distribution line, and the power supply system is configured to perform smoothing of the power output to the power grid based on the detected power output data of the power leaving and entering the power grid by the detection unit.

9. A power supply system wherein smoothing control is performed on the power output to the power grid, the power supply system including distributed power sources, the distributed power source comprising: power generators generating power from renewable energy and detection units detecting the power passing through specific parts of the distribution lines between the distributed type power sources and the power grid, wherein the power supply system not only performs smoothing control when the amount of fluctuation in the value of the detected power output is in excess of a specific threshold value, based on the detected power output data of the detection unit, but also employs as the specific threshold value, the mutually replaceable first threshold value, and a second threshold value which is greater than the first threshold value.

10. The power supply system of claim 9, wherein the power supply system additionally has a master management device and a communications device enabling communication, and not only transmits distributed power source data representing the state of the distributed type power sources and control data with identification information attached thereto in order to specify the power supply systems to the master management device via the communications device, but also receives at least one of the first threshold value and the second threshold value from the master management device via the communications device.

11. The power supply system claimed of claim 9, wherein the second threshold value is more than twice the first threshold value.

12. The power supply system claimed of claim 9, wherein the second threshold value is more 10% and not more than 20% of the rated power output of the distributed power source.

13. The power supply system claimed of claim 9, wherein the first threshold value and the second threshold value are interchanged every specific period.
